(19) United States
(12) Patent Application Publication
(10) Pub. No.: US 2006/0130442 A1
(43) Pub. Date: Jun. 22, 2006

(54) Ozone filter material

(75) Inventors: Heinz Reinhardt, Edingen (DE); Richard Borris, Lenting (DE); Bernd Klausnitzer, Birkenau (DE); Michael Zaplatilek, Birkenau (DE)

Correspondence Address: DAVIDSON, DAVIDSON & KAPPEL, LLC, 485 SEVENTH AVENUE, 14TH FLOOR, NEW YORK, NY, 10018, US

(73) Assignee: CARL FREUDENBERG KG, WEINHEIM (DE)

(21) Appl. No.: 10/514,187

(22) PCT Filed: Mar. 6, 2003
(86) PCT No.: PCT/EP03/02272

§ 371 Date: Dec. 27, 2005

(30) Foreign Application Priority Data
May 3, 2002 (DE) 102 19 966.3

(51) Int. Cl. B01D 46/02

(52) U.S. Cl. 55/341.7

(57) ABSTRACT

An ozone filter material, with a long-lasting ozone degradation capacity, comprising a non-woven fabric filter material containing 200-600 g/m² of activated charcoal impregnated with 0.1-5 wt. % of an organic acid and 0.1-5 wt. % of a bromide and/or iodide salt.

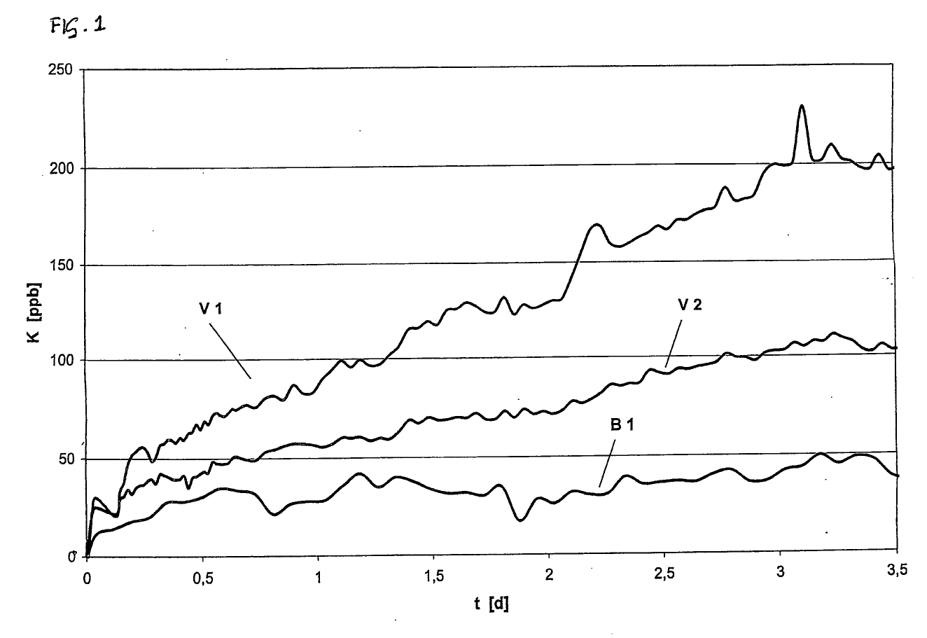

### FIELD OF THE INVENTION

The present invention is directed to an ozone filter material having a long-lasting ozone degradation capacity.

Because of its toxicity and environmentally damaging properties, ozone formed during ionization processes must be degraded. Ozone is produced in various air-purification systems to help reduce unwanted odors in the air or the growth of microorganisms. In order to degrade the remaining ozone, an ozone filter medium composed of an activated carbon layer is typically used.

### BACKGROUND

From the document JP 57177327, a device is known for reducing odors, in which the air mixed with ozone is directed through a filter impregnated with an aqueous bromide and or iodide solution and is subsequently directed through a layer of activated carbon.

However, the ozone degradation capacity of activated carbon decreases already after a short period of time, so that maintaining the ozone degradation capacity either requires a filter change or, however, a quantity of activated carbon that will ensure a sufficient ozone degradation for a longer period of time. In any case, however, disadvantages arise with respect to the costs entailed, since either filters must be frequently replaced or, due to the pressure difference at the filter, more energy must be expended in order to transport the gas through the filter medium.

### SUMMARY OF THE INVENTION

The object of the present invention is to provide an ozone filter material which will have the feature of a distinctly prolonged useful service life with respect to ozone degradation capacity as compared to filter materials having comparable filter engineering parameters, such as pressure difference or activated carbon content.

The objective is achieved in accordance with the present invention by an ozone filter material which is made of a nonwoven material and contains 100-800 g/m² activated carbon, the activated carbon being impregnated with 0.1-5 weight % of an organic acid and 0.1-5 weight % of a bromide salt and/or iodide salt. Such an ozone filter material is distinguished by a long-lasting, virtually constant ozone degradation capacity as compared to other filter materials.

The ozone filter material according to the present invention preferably contains activated carbon that is impregnated with 0.5-3 weight % of a multivalent organic acid and 0.25-1.5 weight % of an alkali or alkaline-earth metal bromide and or of an alkali or alkaline-earth metal iodide.

Especially preferred is an ozone filter material which contains activated carbon impregnated with citric acid and potassium iodide.

The ozone filter material according to the present invention is preferably formed in such a way that the activated carbon is introduced between two nonwoven fabric layers.

Especially preferred is an ozone filter material in which the activated carbon is bound to the nonwoven fabric layers through the use of a binding agent. In this context, the nonwoven fabric layers are preferably composed of synthetic fibers or filaments.

Finally, the present invention relates to the use of an ozone filter material in commercial fresh-air filters, passenger compartment fresh-air filters or in filters used in ventilation purification systems.

The present invention is explained in greater detail in the following on the basis of two comparative examples.

### EXAMPLE

An activated carbon granulate, which has a particle size that passes through a screen having 30×70 mesh size is impregnated in each case with aqueous solutions of citric acid and potassium iodide in such a way that, in the dry state, it contains 1.0 weight % citric acid and 0.5 weight % potassium iodide. The impregnated activated carbon is mixed with a binding agent and is applied in a spraying process in a quantity of 400 g of activated carbon/m² to a nonwoven fabric filter material and covered with another nonwoven fabric filter layer. Subsequently to the pleating and folding process, a filter medium is obtained which, given a filter surface area of 0.164 m², contains 65 g of activated carbon quantity.

### Comparative Example 1

The activated carbon granulate in accordance with Example 1 is impregnated with an aqueous solution of potassium iodide in such a way that, following the drying operation, the activated carbon contains 0.5 weight % of potassium iodide. The processing into a filter material is carried out analogously to Example 1.

### Comparative Example 2

Activated carbon granulate in accordance with Example 1 is processed analogously to Example 1 into a filter medium.

Illustration 1 shows the ozone degradation capacity of Example (B1) and of comparative Examples (V1, V2) obtained using the manufactured ozone filter media. In the process, the test was performed in a flow channel having a flow rate of 1.5 m/s and a volumetric flow rate of approximately 100 m³/h under laboratory conditions and at a room temperature of approximately 23° C. On the unprocessed air side, a constant ozone concentration of 750 ppb (+/−50 ppb) was set using a commercial ozone generator. The filter medium according to the present invention exhibits a continuously low ozone gas concentration (K in [ppb]) on the cleaned gas side (degradation capacity approximately 93% following 3.5 days [d]), while the comparative examples only yielded 86% and, respectively, approximately 73% ozone degradation after three days test duration.

1-7. (canceled)

8. An ozone filter material comprising:
a nonwoven fabric filter material containing 100 to 800 g/m² of activated carbon impregnated with 0.1-5 weight % of an organic acid and 0.1 to 5 weight % of a bromide salt and/or of an iodide salt.

9. The ozone filter material as recited in claim 8 wherein the activated carbon is impregnated with 0.5-3 weight % of a multivalent organic acid and 0.25-1.5 weight % of an alkali or alkaline-earth metal bromide and/or of an alkali or alkaline-earth metal iodide.

10. The ozone filter material as recited in claim 8 wherein the activated carbon is impregnated with citric acid and potassium iodide.

11. The ozone filter material as recited in claim 8 wherein nonwoven fabric filter material includes two nonwoven fabric layers, the activated carbon being located between the two nonwoven fabric layers.

12. The ozone filter material as recited in claim 11 wherein the activated carbon is bound to the nonwoven fabric layers through a binding agent.

13. The ozone filter material as recited in claim 11 wherein the nonwoven fabric layers are composed of synthetic fibers or filaments.

14. A method for utilizing the ozone filter material as recited in claim 8, the method comprising placing the ozone filter material in commercial fresh-air filters, passenger compartment fresh-air filters or in ventilation filters.
